(19) United States
(12) Patent Application Publication
(10) Pub. No.: US 2012/0242929 A1
(43) Pub. Date: Sep. 27, 2012

(54) LIGHTING APPARATUS AND LIQUID CRYSTAL DISPLAY COMPRISING SAME

(75) Inventor: Hideki Ohyama, Osaka (JP)

(73) Assignee: SHARP KABUSHIKI KAISHA, Osaka (JP)

(21) Appl. No.: 13/514,122

(22) PCT Filed: Nov. 10, 2010
(86) PCT No.: PCT/JP2010/006606

§ 371 Date: Jun. 6, 2012

(30) Foreign Application Priority Data
Dec. 11, 2009 (JP) 2009-281962

(51) Int. Cl. G02F 1/1335; H05B 37/02

(52) U.S. Cl. 349/61; 315/312

(57) ABSTRACT

Disclosed is a lighting apparatus including an LED substrate and an LED driver circuit substrate. The LED substrate has a terminal section formed thereon, which is electrically connected to the LED of the LED substrate. The LED driver circuit substrate has a socket section formed thereon, which is electrically connected to the driver circuit and is configured to allow attachment and detachment of the terminal section of the LED substrate.

### TECHNICAL FIELD

The present invention relates to a lighting apparatus having LEDs as the light source and to a liquid crystal display device equipped with the lighting apparatus.

### BACKGROUND ART

Liquid crystal display devices that perform transmissive display have a backlight unit, which is the lighting apparatus disposed on the back side of the liquid crystal display panel.

Generally, a backlight unit includes a light source such as LEDs (Light Emitting Diodes) and a light guide plate that converts the light from the light source into a planar light and projects the planar light on the back side of the liquid crystal display panel. Among the backlight units, so-called “edge-lit type” backlight units, where the light source is provided along an edge surface of the light guide plate, are in wide use.

Here, a conventional edge-lit type backlight unit is described with reference to FIG. 10, which is a perspective view, and FIG. 11, which is a partially enlarged side view.

A backlight unit 100 has a rectangular board-shaped light guide plate 101 and a dish-shaped frame 102 housing the light guide plate 101. The frame 102 includes a rectangular bottom plate section 102a, which abuts against the entire bottom surface of the light guide plate 101, the bottom surface being on the opposite side from the light-projecting surface 101a of the light guide plate 101, and side wall sections 102b adjoining the four sides of the bottom plate section. The side wall sections 102b abut on the respective side surfaces of the light guide plate 101.

On one side wall section 102b of the frame 102, a plurality of LED substrates 104 each including a plurality of LEDs 103 are securely mounted. As shown in FIG. 11, in the side wall section 102b of the frame 102, an opening 105 is provided for each of the LEDs 103 for installation of the LEDs 103. The LED substrates 104 are held in place by the side wall section 102b of the frame 102 and a light-shielding member 106 while the LEDs 103 are fitted in the respective openings 105. The LED substrates 104 are connected to an LED driver circuit substrate (not shown) for controlling the driving of the individual LEDs through cables 108.

The light-shielding member 106 has an L-shaped cross section, and covers the back surface of the LED substrate 104 and the border portion of the light-projecting surface 101a of the light guide plate 101. The LED substrate 104 is fixed to the side wall section 102b of the frame 102 with screws 107 together with the light-shielding member 106.

Patent Document 1 discloses a lighting apparatus in which a plurality of insertion slots are formed in a side surface of the metal frame that houses a light guide plate, and LEDs are inserted into the respective insertion slots from outside. This way, the disclosure aims at reducing the frame region constituting the outer frame of the lighting apparatus and the thickness of the light guide plate.

### RELATED ART DOCUMENTS

Patent Documents
Patent Document 1: Japanese Patent Application Laid-Open Publication No. 2007-42338

### SUMMARY OF THE INVENTION

### Problems to be Solved by the Invention

However, in the conventional lighting apparatus described above, the LED substrates are fixed to the frame with screws, and the LED substrates and the LED driver circuit substrate need to be connected with cables, which increases the number of assembly steps.

Also, if an LED fails to light and needs to be replaced with a new LED, the cable and screws have to be removed, which makes the repair and replace process very cumbersome.

The present invention was devised in consideration of the issues described above, and is mainly aiming at simplifying the manufacturing step of lighting apparatuses and facilitating the replacement of light source LEDs of the lighting apparatuses.

### Means for Solving the Problems

In order to achieve the above-mentioned objective, according to the present invention, the terminal section of the LED substrate is configured such that it can be attached to and detached from the socket section of the LED driver circuit substrate.

That is, the present invention was devised for lighting apparatuses including an LED substrate equipped with a light source LED, and an LED driver circuit substrate equipped with a driver circuit that controls the drive of the light-emitting state of the LED in the LED substrate.

The LED substrate has a terminal section formed thereon, which is electrically connected to the LEDs of the LED substrate. The LED driver circuit substrate has a socket section formed thereon, which is electrically connected to the above-mentioned driver circuit and is configured to allow attachment and detachment of the terminal section of the LED substrate.

Functions

Next, functions of the present invention are described.

In the present invention, because a socket section that allows attachment and detachment of the terminal section of the LED substrate is formed on the LED driver circuit substrate, no wiring is needed to connect the LED substrate and the LED driver circuit substrate when a lighting apparatus is manufactured. That is, by attaching the terminal section to the socket section, the lighting apparatus can easily be manufactured. On the other hand, when any of the LEDs fails to light, the LED can easily be replaced with new one by detaching the terminal section from the socket section.

### Effects of the Invention

According to the present invention, the terminal section of the LED substrate is configured to be attachable to and detachable from the socket section of the LED driver circuit substrate to make it easy to manufacture a lighting apparatus and to replace the light source LEDs of the lighting apparatus.

### BRIEF DESCRIPTION OF THE DRAWINGS

FIG. 1 is an exploded perspective view showing a main section of a lighting apparatus according to Embodiment 1.

FIG. 2 is a side view showing an LED substrate and an LED driver circuit substrate, which are separate from one another.

FIG. 3 is a side view showing an LED substrate attached to the light guide plate, a light-shielding member, and an LED driver circuit substrate.

FIG. 4 is a cross-sectional view showing an LED substrate, a light guide plate, and the like housed in a chassis and a bezel.

FIG. 5 is an exploded perspective view of a lighting apparatus according to Embodiment 1.

FIG. 6 is a cross-sectional view of Embodiment 2, showing an LED substrate attached to an LED driver circuit.

FIG. 7 is a plan view of Embodiment 2, showing an LED substrate attached to the LED driver circuit.

FIG. 8 is a cross-sectional view showing a modification example of Embodiment 2.

FIG. 9 is a side view showing a main section of a liquid crystal display device according to Embodiment 3.

FIG. 10 is an exploded perspective view showing a main section of a conventional lighting apparatus.

FIG. 11 is a cross-sectional view showing an LED substrate and a light-shielding member attached to a conventional light guide plate.

### DETAILED DESCRIPTION OF EMBODIMENTS

Below, embodiments of the present invention are described in detail with reference to figures. It should be noted that the present invention is not limited to the embodiments described below.

### Embodiment 1 of the Invention

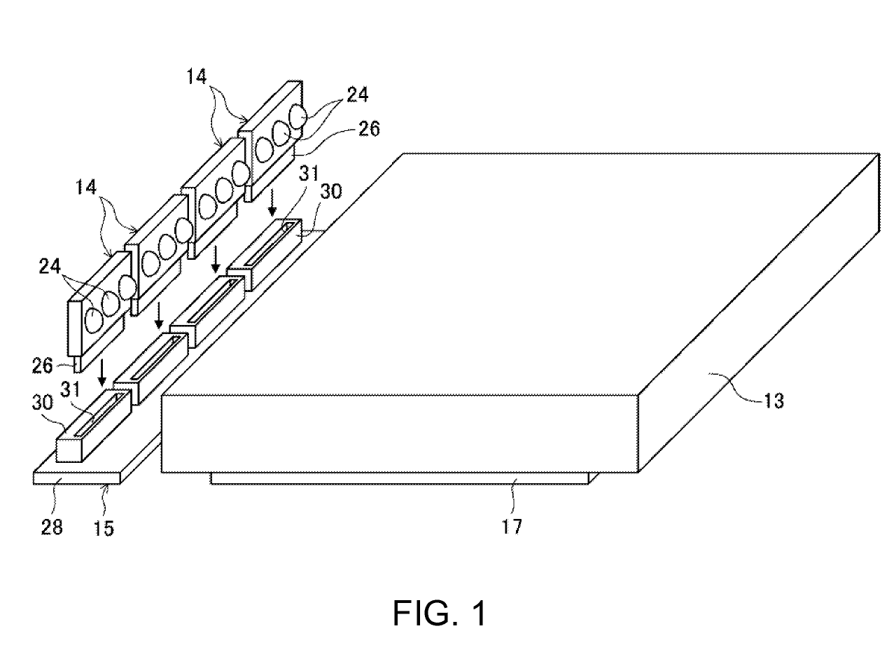

FIG. 1 to FIG. 6 show Embodiment 1 of the present invention.

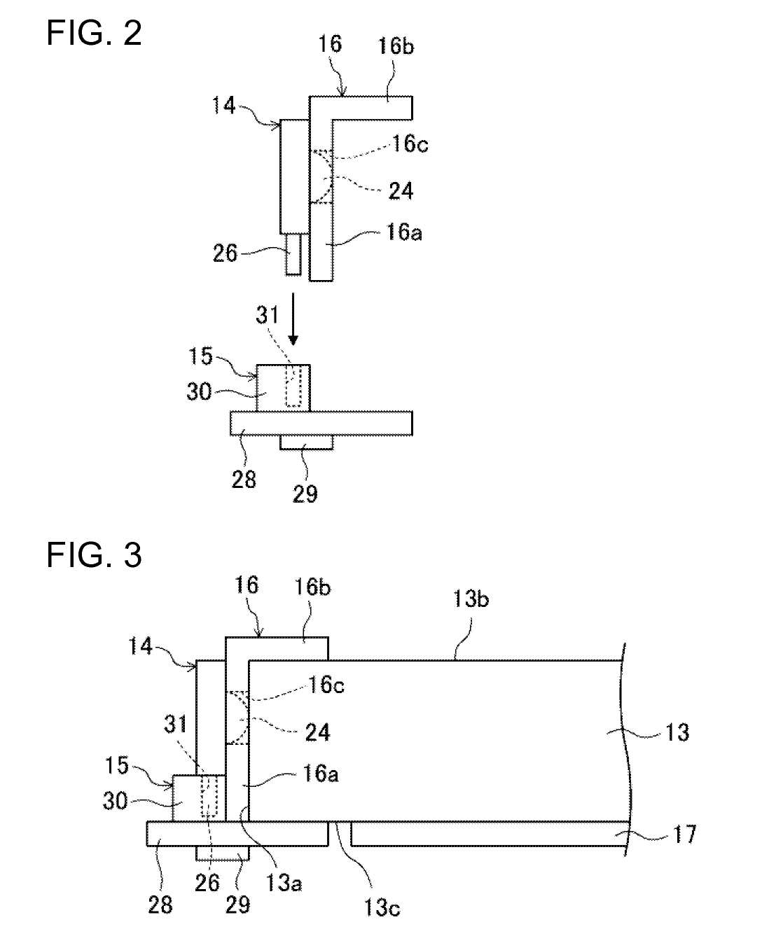

FIG. 1 is an exploded perspective view showing a main section of a backlight unit 11 according to Embodiment 1. FIG. 2 is a side view showing an LED substrate 14 and an LED driver circuit substrate 15, which are separated from one another. FIG. 3 is a side view showing the LED substrate 14 attached to a light guide plate 13, a light-shielding member 16, and the LED driver circuit substrate 15.

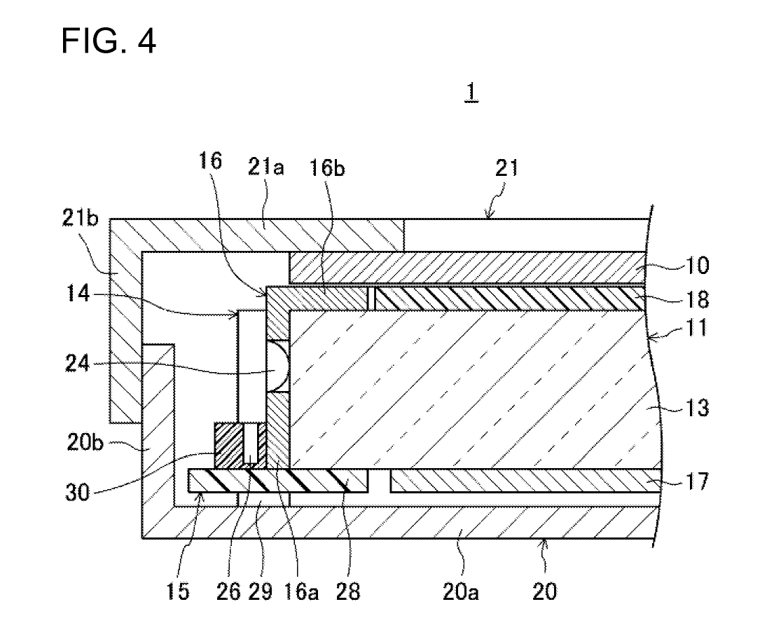

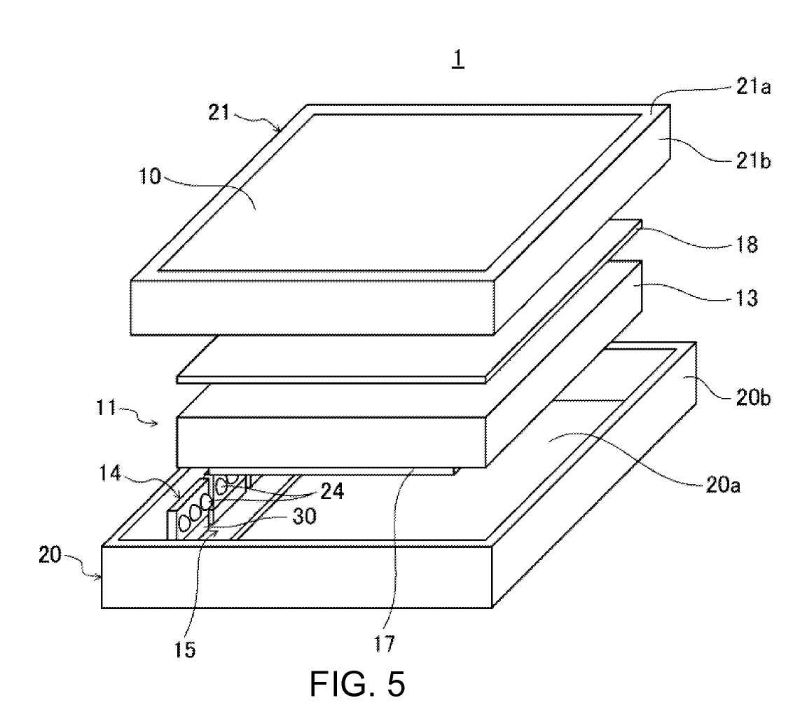

FIG. 4 is a cross-sectional view showing the LED substrate 14, the light guide plate 13, and the like housed in a chassis 20 and a bezel 21. FIG. 5 is an exploded perspective view of the backlight unit 11 according to Embodiment 1.

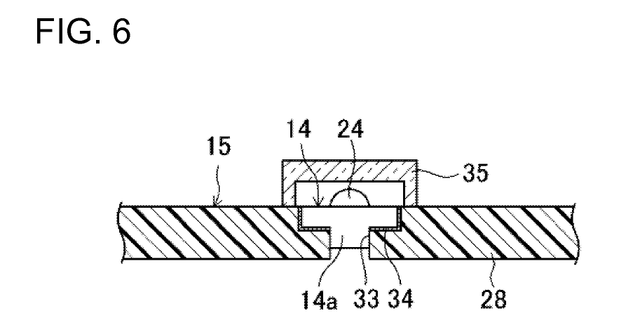

As shown in FIG. 6, a liquid crystal display device 1 of Embodiment 1 includes a liquid crystal display panel 10 and a backlight unit 11, which is a lighting device disposed at the back side of the liquid crystal display panel 10 (the side opposite from the user's side). Also, the liquid crystal display device 1 is configured such that the liquid crystal display panel 10 selectively transmits the light from the backlight unit 11 to perform the transmissive display.

The liquid crystal display panel 10, detailed illustration of which is not provided here, includes, for example, an active matrix substrate with a plurality of TFTs (Thin Film Transistors) and pixel electrodes formed thereon for respective pixels, an opposite substrate facing the active matrix substrate, and a liquid crystal layer sealed in between these substrates.

The backlight unit 11 is so-called edge-lit type, and as shown in FIG. 4 and FIG. 5, includes a light guide plate 13, a plurality of LED substrates 14, an LED driver circuit substrate 15, a light-shielding member 16, a reflection plate 17, and a diffusion plate 18. Also, the backlight unit 11 and the liquid crystal display panel 10 are housed in a space between the chassis 20 and the bezel 21.

Below, members constituting the backlight unit 11 are described in detail.

LED Substrate

As shown in FIG. 1 to FIG. 4, the LED substrate 14 includes LEDs 24 as the light source, where the plurality LEDs 24 are mounted on a surface of the substrate, and a terminal section 26 which is protruding.

As shown in FIG. 1, the terminal section 26 is formed in the shape of a thin board extending along a surface of the LED substrate 14 on which surface the LED is provided. The terminal section 26 includes a conductive layer (not shown) electrically connected to the corresponding LEDs 24.

Light Guide Plate

A light guide plate 13 is made of a transparent resin such as acrylic resin, and has a flat rectangular shape. Also, the light guide plate 13 has a side surface 13a through which the light from LEDs 24 of the LED substrates 14 enters, a light-projecting surface 13b which is perpendicular to the side surface 13a and from which the light is projected, and a bottom surface 13c which is at the opposite position from the light-projecting surface 13b. The LED substrates 14 are disposed in parallel with the side surface 13a of the light guide plate.

Reflection Plate and Diffusion Plate

On the light-projecting surface 13b of the light guide plate 13, a diffusion plate 18 that diffuses the light is disposed. Although not illustrated, a prism sheet and the like are also disposed covering the diffusion plate 18. On the other hand, on the bottom surface 13c of the light guide plate 13, a reflection plate 17 made of a metal sheet or the like is disposed.

The light that entered into the light guide plate 13 through the side surface 13a is reflected and guided inside the light guide plate 13. The light that is projected out from the bottom surface 13c of the light guide plate 13 is reflected by the reflection plate 17 and re-enters the light guide plate 13. Consequently, through the light-projecting surface 13b, uniform light is projected. This projected light is diffused as it passes through the diffusion plate 18, and then is supplied to the liquid crystal display panel 10.

LED Driver Circuit Substrate

An LED driver circuit substrate 15 has a driver circuit 29 that controls the driving of LEDs 24 of the LED substrate 14, and is disposed in parallel with the bottom surface 13c of the light guide plate 13. The LED driver circuit substrate 15 includes a circuit substrate 28, the driver circuit 29, and the socket section 30.

The circuit substrate 28 is an insulating substrate. On one side of the circuit substrate 28, a driver circuit 29 composed of IC chips and the like is mounted. On the other side of the circuit substrate 28, a plurality of socket sections 30 are formed for the plurality of respective LED substrates 14. The socket section 30 is electrically connected to the driver circuit 29 and is configured to allow attachment and detachment of the terminal section 26 of each of the LED substrates 14.

That is, the socket section 30 is formed as a protrusion on the circuit substrate 28, and has a slit-shaped insertion slot 31 into which the terminal section 26 of the LED substrate 14 is inserted. On the inner surface of the insertion slot 31, a conductive layer (not shown) is formed. Although not illustrated, a cluster of wirings is formed on both sides of the circuit substrate 28, which are connected together through a through hole formed in the circuit substrate 28. One end of the wiring is connected to the conductive layer in the insertion slot 31 of the socket section 30, while the other end of the wiring is connected to the driver circuit 29.

Thus, when the terminal section 26 of the LED substrate 14 is attached to the insertion slot 31 in the socket section 30 of the LED driver circuit substrate 15, the LED 24 is electrically connected to the driver circuit 29 through the terminal section 26 and the socket section 30.

Light-Shielding Member

The light-shielding member 16 is made of a metal material, for example, and includes a first light-shielding section 16a disposed between the side surface 13a of the light guide plate 13 and the LED substrate 14, and a second light-shielding section 16b that partially blocks the border portion of the light-projecting surface 13b of the light guide plate 13 from the light. The light-shielding member 16, together with the first light-shielding section 16a and the second light-shielding section 16b, has an L-shaped cross section.

The first light-shielding section 16a has an opening 16c, which is a transmitting section that allows the light from the LED 24 to pass through. The opening 16c is formed to about the same size as the exterior of the LED 24. When the LED 24 is fitted in the opening 16c, the LED substrate 14 latches against the light-shielding member 16.

Besides the opening 16c, for example, a transmitting section may also be formed of a transparent member to transmit the light from the LED 24.

The light guide plate 13 is held by the LED driver circuit substrate 15 and the second light-shielding section 16b of the light-shielding member 16 when the terminal section 26 of the LED substrate 14 is attached to the socket section 30 of the LED driver circuit substrate 15. In this state, the first light-shielding section 16a of the light-shielding member 16 abuts against the side surface 13a of the light guide plate 13. Thus, the LED driver circuit substrate 15, the LED substrate 14, and the light-shielding member 16 can easily be mounted to the light guide plate 13.

Chassis and Bezel

As shown in FIG. 4 and FIG. 5, the chassis 20 is disposed adjacent to the LED driver circuit substrate 15 and the reflection plate 17 on the side opposite from the light guide plate 13. The chassis 20 is formed into a dish shape including a rectangular board-shaped bottom section 20a and four side wall sections 20b which abut against the respective four sides of the bottom section 20a. The light guide plate 13, the light-shielding member 16, the LED substrates 14, the LED driver circuit substrate 15, the diffusion plate 18, and the reflection plate 17 are housed in the chassis 20.

On the other hand, the bezel 21 is formed as a metal frame, and includes a rectangular frame-shaped front surface section 21a and four side wall sections 21b extending from respective four sides of the front surface section 21a to the chassis 20. With the liquid crystal display panel 10 disposed over the diffusion plate 18, the bezel 21 is engaged to the chassis 20 covering the liquid crystal display panel 10.

Thus, with the bezel 21 engaged to the chassis 20, the side wall sections 21b of the bezel 21 are in contact with the respective side wall sections 20b of the chassis 20, while the front surface section 21a of the bezel 21 covers the joint of the second light-shielding section 16b of the light-shielding member 16 and the diffusion plate 18. The liquid crystal display device 1 is configured in this manner.

Effects of Embodiment 1

Therefore, in Embodiment 1, the terminal section 26 of the LED substrate 14 is configured such that it can be attached to and detached from the socket section 30 of the LED driver circuit substrate 15, which can facilitate the manufacturing of the backlight unit 11 and the liquid crystal display device 1 including the backlight unit 11. Also, according to Embodiment 1, when any LED 24 fails to light, the defective LED 24 can easily be replaced with new one.

That is, because the LED driver circuit substrate 15 is configured to include the socket section 30 that allows the attachment and detachment of the terminal section 26 of the LED substrate 14, the wiring to connect the LED substrate 14 to the LED driver circuit substrate 15 becomes unnecessary when manufacturing the backlight unit 11.

Therefore, by configuring the terminal section 26 such that it is attachable to the socket section 30, the backlight unit 11 can easily be manufactured. On the other hand, when any LED 24 fails to light, the LED 24 can easily be replaced by detaching the terminal section 26 from the socket section 30.

Further, because the LED substrates 14 are disposed in parallel with the side surface 13a of the light guide plate 13, and the LED driver circuit substrate 15 is disposed in parallel with the bottom surface 13c of the light guide plate 13, the backlight unit 11 can be applied to an edge-lit style backlight unit.

Because the backlight unit 11 includes the light-shielding member 16 having the first light-shielding section 16a and the second light-shielding section 16b, light leakage from the side surface 13a of the light guide plate 13 can be blocked by the first light-shielding section 16a. Also, the light leakage from a portion of the light-projecting surface 13b at the edge of the light guide plate 13 can effectively be blocked by the second light-shielding section 16b. Consequently, the light entering the light guide plate 13 from the opening 16c formed in the first light-shielding section 16a can appropriately be guided to the inside of the light guide plate 13.

Further, because the transmitting section 16c that transmits the light from the LED 24 is constituted of the opening 16c formed in the first light-shielding section 16a, the LED 24 can be disposed inside the opening 16c. As a result, the exterior of the backlight unit 11 can be made more compact.

In addition, when the terminal section 26 is attached to the socket section 30, the light guide plate 13 is held between the LED driver circuit substrate 15 and the second light-shielding section 16b of the light-shielding member 16. This facilitates the installation of the LED driver circuit substrate 15, the LED substrate 14, and the light-shielding member 16 to the light guide plate 13. Therefore, the LED substrate 14 can very easily be secured to the light guide plate 13.

Further, because the light-shielding member 16 is formed of a metal material, the light-shielding member 16 functions as a heat dissipating member that speeds up the heat reduction of the LED 24.

### Embodiment 2

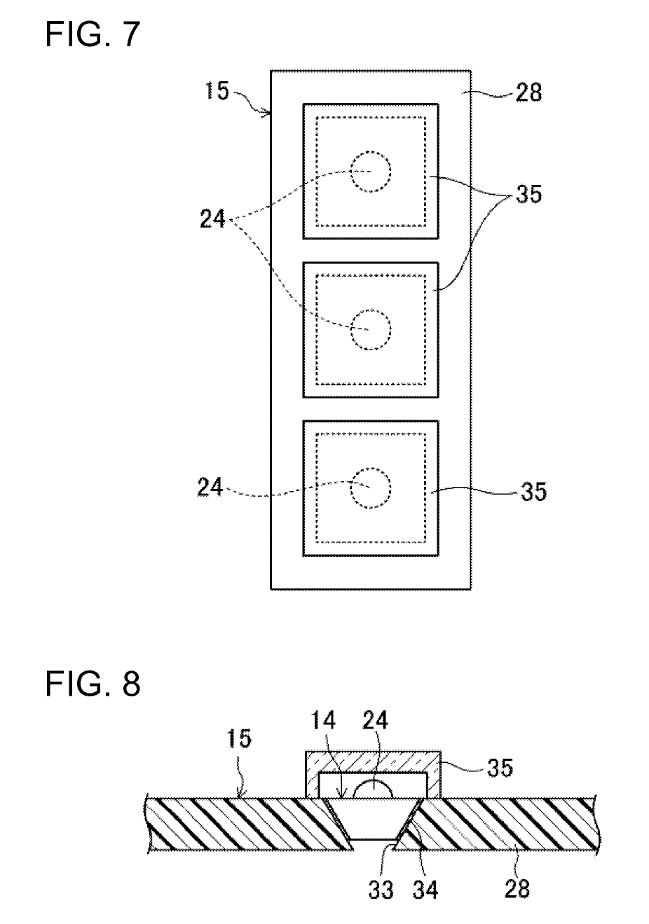

FIG. 6 and FIG. 7 show Embodiment 2 of the present invention. In the description of this embodiment and others that follow, the same reference characters used in FIG. 1 to FIG. 5 are provided for identical parts and detailed descriptions of them are omitted.

FIG. 6 is a cross-sectional view of Embodiment 2, showing an LED substrate 14 attached to an LED driver circuit substrate 15. FIG. 7 is a plan view of Embodiment 2, showing the LED substrate 14 attached to the LED driver circuit substrate 15.

The lighting apparatus of Embodiment 2 is a backlight unit 11 of so-called direct-lighting type, in contrast to the backlight unit 11 of Embodiment 1, which is edge-lit type. That is, the direct-lighting type backlight unit 11 is configured to supply the light from the LED 24 directly to the liquid crystal display panel 10, i.e., not through the light guide plate 13.

The LED driver circuit substrate 15 has a plurality of openings 33 formed in the circuit substrate 28. The openings 33 are disposed at prescribed intervals in between. A conductive layer 34 is formed at least over a portion of the inner surface of the opening 33.

In Embodiment 2, a socket section 30 is constituted of the opening 33 formed in the circuit substrate 28. That is, the opening 33 corresponds to the insertion slot 31 in the socket section 30 of Embodiment 1.

The inner diameter of the opening 33 on the side of one surface of the LED driver circuit substrate 15 (the front surface facing the liquid crystal display panel 10) is larger than the inner diameter on the other side. As a result, as shown in FIG. 6, the opening 33 is formed to have a stepped cross section.

The LED substrate 14, on the other hand, has a protrusion 14a on the side opposite from the side on which LED 24 is provided (i.e., on the back side). On the side surface of the LED substrate 14 including the protrusion 14a, a conductive layer (now shown) is provided. As a result, the back side of the LED substrate 14 has a stepped cross section. The terminal section 26 of the LED substrate 14 of Embodiment 2 is formed of the side surface of the LED substrate 14.

As shown in FIG. 6, when the protrusion 14a is inserted into the opening 33, the entire LED substrate 14 is fitted in the opening 33. In this state, the conductive layer 34 of the opening 33 comes in contact with the conductive layer of the LED substrate 14 (not shown) and establishes the conductivity.

Also, the LED driver circuit substrate 15 has rectangular cover-shaped diffusion plates 35 that cover the respective LEDs 24. Each LED substrate 14 has one LED 24, and one diffusion plate 35 is disposed for each LED 24.

Effects of Embodiment 2

Therefore, according to Embodiment 2, similar effects as in Embodiment 1 described above can be obtained. Also, because the socket section 30 is formed as the opening 33 in which the entire LED substrate 14 is fitted, and the terminal section 26 is constituted of the side surface of the LED substrate 14, the thickness of the entire backlight unit 11 can significantly be reduced while the LED substrates 14 remain attachable to and detachable from the LED driver circuit substrate 15.

Further, the LED substrate 14 can very easily be attached to the LED driver circuit substrate 15, and conductivity between the terminal section 26 and the opening 33, the socket section, can reliably be established.

Modification Example

FIG. 8 is a cross-sectional view showing a modification example of Embodiment 2.

In Embodiment 2, the LED substrate 14 and the opening 33 of the LED driver circuit substrate 15 are formed to have stepped cross sections. In contrast, in this modification example, they are formed to have tapered cross sections.

That is, the opening 33 is formed to have a tapered cross section, which inner diameter decreases from one surface side of the LED driver circuit substrate 15 (i.e., the side of the liquid crystal display panel 10) to the other surface side. The side surface of the LED substrate 14 is also formed to have a tapered cross section. The terminal section 26 is constituted of the tapered portion of the LED substrate 14.

A conductive layer 34 is formed on the inner surface of the opening 33. A conductive layer (not shown) is also formed on the side surface of the LED substrate 14. As shown in FIG. 8, the entire LED substrate 14 is fitted in the opening 33 of the LED driver circuit substrate 15 to establish the connection.

Therefore, in this modification example, similar effects as in Embodiment 2 can be obtained.

### Embodiment 3

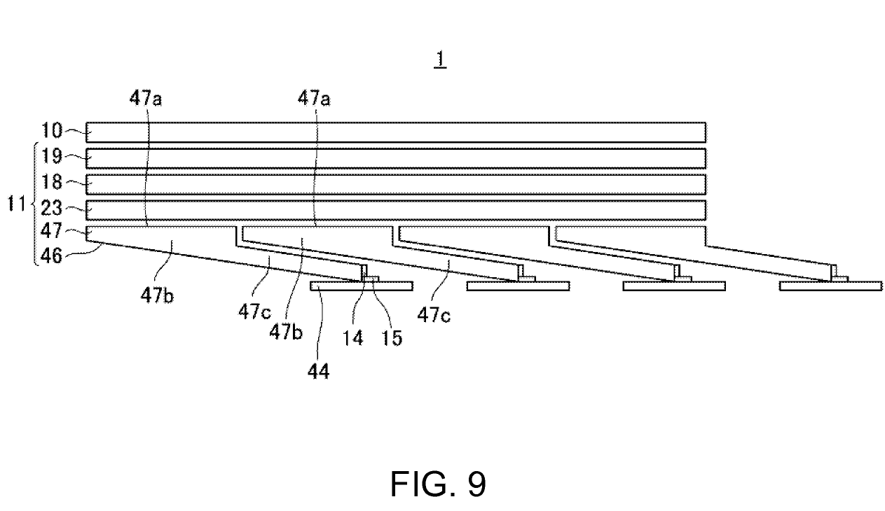

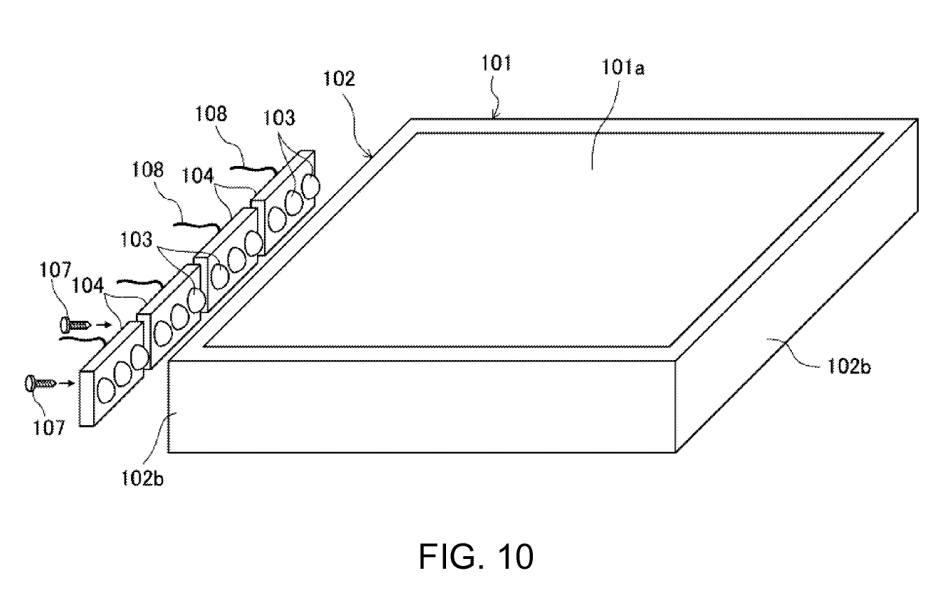

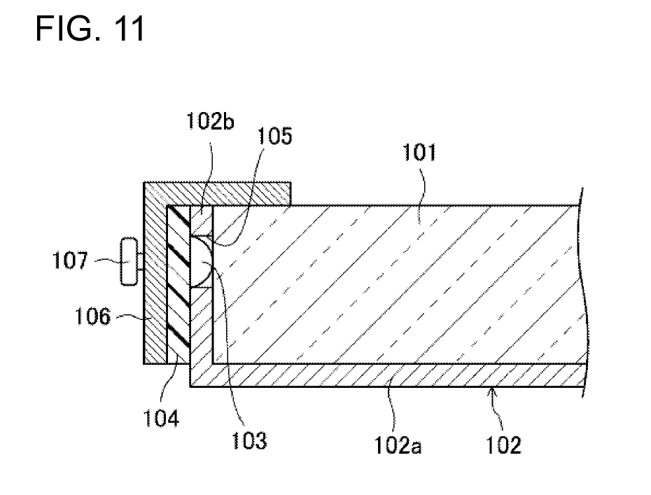

FIG. 9 shows Embodiment 3 of the present invention.

FIG. 9 is a side view showing a main section of a liquid crystal display device 1 according to Embodiment 3.

The lighting apparatus of Embodiment 3 is constituted of a so-called tandem style backlight unit 11.

As shown in FIG. 9, the backlight unit 11 has a plurality of light guide bodies 47, a transparent plate 23, a diffusion plate 18, and an optical sheet 19.

The light guide body 47 takes the light projected from the LED 24 and emits the planar light from a light-emitting surface 47a. The light-emitting surface 47a emits the light toward an illumination object. In Embodiment 3, the light guide body 47 is configured to be a tandem style. That is, the light guide body 47 includes a light-emitting section 47b having the light-emitting surface 47a, and a light guide section 47c that guides the light from the LED 24 to the light-emitting section 47b. The thickness of the light-emitting section 47b and the thickness of the light guide section 47c are different at least at the location where they meet. Also, over the light guide section 47c of a light guide body 47, the light-emitting section 47b of the adjacent light guide body 47 is disposed in such a manner as to rest on the light guide section 47c. A reflective sheet 46 is disposed on the back side of the light guide section 47c. Thus, the plurality of light guide bodies 47 form one flat light-emitting surface (the light-emitting surface of the entire backlight unit 11).

LEDs 24 are provided on the LED substrates 14. The LED substrate 14 and the LED driver circuit substrate 15 are configured in the same manner as in the Embodiment 1 described above. The LED substrate 14 is disposed in parallel with the side surface of the light guide section 47c of the light guide body 47. Thus, the light from the LED 24 enters the side surface of the corresponding light guide section 47c.

Also, at the bottom of the light guide section 47c, a substrate 44 is disposed, and on the surface of the substrate 44, an LED driver circuit substrate 15 is mounted. Also, as in Embodiment 1 described above, the terminal section 26 of the LED substrate 14 is attached to the socket section 30 of the LED driver circuit substrate 15.

Therefore, according to Embodiment 3, similar effects as in Embodiment 1 described above can be obtained. Further, if any LED 24 fails, the LED 24 can easily be replaced by detaching the corresponding light guide body 47 and separating the LED substrate 14 from the LED driver circuit substrate 15.

### Other Embodiments

Although the lighting apparatus according to the present invention is described as a backlight unit used for the liquid crystal display device in the above-mentioned embodiments, the present invention is not limited to such. The present invention is widely applicable to lighting apparatuses using LEDs as a light source.

### INDUSTRIAL APPLICABILITY

As described above, the present invention is useful for lighting apparatuses using LEDs as a light source, and for the liquid crystal display device equipped with the lighting apparatus.

### DESCRIPTION OF REFERENCE CHARACTERS

1 liquid crystal display device
10 liquid crystal display panel
11 backlight unit (lighting apparatus)
13 light guide plate
13a side surface
13b light-projecting surface
13c bottom surface
14 LED substrate
14a protrusion
15 LED driver circuit substrate
16 light-shielding member
16a first light-shielding section
16b second light-shielding section
16c opening (transmitting section)
24 LED
26 terminal section
28 circuit substrate
29 driver circuit
30 socket section
31 insertion slot
33 opening

1. A lighting apparatus comprising:
an LED substrate with light-source LEDs formed thereon; and
an LED driver circuit substrate including a driver circuit that controls driving of the light-emitting operation of LEDs provided on said LED substrate,
wherein said LED substrate has a terminal section formed thereon, said terminal section being electrically connected to the LED of said LED substrate, and
wherein said LED driver circuit substrate has a socket section formed thereon, which socket section is electrically connected to said driver circuit and is configured to allow attachment and detachment of the terminal section of said LED substrate.

2. The lighting apparatus according to claim 1, further comprising:
a light guide plate having a side surface through which light from the LED of said LED substrate enters, a light-projecting surface which is perpendicular to said side surface and from which the light is projected, and a bottom surface disposed opposite from said light-projecting surface,
wherein said LED substrate is disposed in parallel with the side surface of said light guide plate, and
wherein said LED driver circuit substrate is disposed in parallel with the bottom surface of said light guide plate.

3. The lighting apparatus according to claim 2, further comprising:
a light-shielding member including a first light-shielding section disposed between the side surface of said light guide plate and said LED substrate, and a second light-shielding section partially blocking a border portion of the light-projecting surface of said light guide plate,
wherein said first light-shielding section has a transmitting section formed therein, through which transmitting section the light from the LED is transmitted.

4. The lighting apparatus according to claim 3, wherein said transmitting section is an opening formed in said first light-shielding section.

5. The lighting apparatus according to claim 3,
wherein said light guide plate is held by said LED driver circuit substrate and the second light-shielding section of said light-shielding member when the terminal section of said LED substrate is attached to the socket section of said LED driver circuit substrate.

6. The lighting apparatus according to claim 3, wherein said light-shielding member is made of a metal material.

7. The lighting apparatus according to claim 1,
wherein said socket section is formed on said LED driver circuit substrate and is constituted of an opening in which the entire LED substrate is fitted, and
wherein said terminal section is constituted of the side surface of said LED substrate.

8. A liquid crystal display device comprising:
the lighting apparatus according to claim 1; and
a liquid crystal display panel disposed facing said lighting apparatus.
